(19) United States
(12) Patent Application Publication
(10) Pub. No.: US 2006/0262717 A1
(43) Pub. Date: Nov. 23, 2006

(54) Method and apparatus for providing enhanced connection capabilities to digital subscriber line (DSL) subscribers

(75) Inventors: Thomas T. Wiatt, Austin, TX (US); Bobby R. Sams, Austin, TX (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 11/135,238

(22) Filed: May 23, 2005

(51) Int. Cl. H04J 3/14

(52) U.S. Cl. 370/225

(57) ABSTRACT

A network includes a telephone line connecting user and CO DSL devices. The CO device connects through a broadband network to an ISP such that a DSL path extends from the user device over a digital path of the telephone line to the CO device and through the broadband network to the ISP to enable a DSL connection to be established between the user and the ISP. The CO device connects through the PSTN to the ISP such that an analog path extends from the user device over an analog path of the telephone line to the CO device and through the PSTN to the ISP to enable a dial-up connection to be established between the user and the ISP. A user uses the user device to establish a DSL connection. The user device automatically establishes a dial-up connection to replace the DSL connection upon the DSL connection being interrupted.

### BACKGROUND OF THE INVENTION

1. Field of the Invention

The present invention relates to digital subscriber line (DSL) technology.

2. Background Art

Digital subscriber line (DSL) technology enables high-speed digital transmission on conventional telephone lines. Using DSL technology, a telephone line has two data paths. The first data path is a high-frequency path for digital data and is referred to as a “digital subscriber line” or “DSL”. The second data path is a low-frequency path for analog data such as voice telephony and voice-based modem communications. DSL technology enables the simultaneous transmission of digital data and analog data over the telephone line as the digital data and the analog data are transmitted in separate frequency channels.

The DSL of the telephone line may be continuously available to a user thus making the DSL an “always on” connection. A DSL connection device connected to the end of the telephone line terminating at the user premises and another DSL connection device connected to the end of the telephone line terminating at a central office (CO) enables a DSL provider to provide DSL services to the user. The CO connects to a broadband access network that connects to Internet Service Providers (ISP). As such, the user (e.g., the user's computer) and an ISP are enabled to communicate digital data to one another over a DSL network path which includes the DSL thereby providing the user with Internet service.

The CO also connects with the Public Switched Telephone Network (PSTN) thereby connecting the user (e.g., the user's telephone and the user's computer) to the PSTN via the analog path of the telephone line. The PSTN connects with other users and the ISPs thereby connecting the user to the other users and the ISPs. Thus, the user and other users are enabled to communicate voice telephony communications with one another using telephones over an analog network path which includes the analog path of the telephone line. As a result, the user is provided with traditional telephone service. Likewise, the user and the ISPs are enabled to communicate digital data with one another using voice-based modems over the analog network path thereby providing the user with Internet service. In the latter case, voice-based modems transform digital data to resemble voice telephony communications that the PSTN is designed to convey.

The connection between the user and an ISP over the analog path of the telephone line is known as a “dial-up connection”. The connection between the user and the ISP over the digital path (i.e., the DSL) of the telephone line is known as a “DSL connection”. Data transmission speed between the user and the ISP is relatively much faster over the DSL connection than the dial-up connection. A DSL connection has been positioned as a more powerful and technically advanced alternative to a dial-up connection. However, a DSL connection is subject to interruptions and outages, and therefore, while more convenient for a user than initiating a discrete dial-up session for each Internet connection, does not entirely fulfill the “always on” promise.

The user's DSL connection device is typically a modem (or a gateway when combined with wireless connectivity and/or routing for use with multiple user computers). The DSL connection device at the CO is typically a Digital Subscriber Line Access Multiplier (DSLAM) or a Remote Terminal (RT). The DSL connection device at the CO multiplexes digital data received from the user and then transmits the digital data through the broadband access network to the ISP. The DSL connection device at the CO uses filtering to divert the analog data received from the user to traditional switching equipment in the CO for receipt by the PSTN, thereby forming a separate circuit independent of the DSL network path. Thus, a service outage along the DSL network path does not affect the analog network path.

A DSL provider provisions DSL services to a new DSL user through a process that enables a DSL connection (“DSL sync”) within a given time period (such as five days) following the new DSL user's order. When the DSL sync is available the new DSL user can access a customer website provided by the DSL provider in order to register their new DSL service and begin performing Internet browsing, email, and other applications using the DSL connection. Typically, DSL providers do not enable new DSL users to register and begin using Internet service via a dial-up connection while the DSL sync is unavailable.

### BRIEF DESCRIPTION OF THE DRAWINGS

FIG. 1 illustrates a block diagram of a communications network having an enhanced digital subscriber line (DSL) connection device for providing enhanced Internet service connection capabilities to a user in accordance with the present invention;

FIG. 2 illustrates a block diagram of the user premises in the communications network shown in FIG. 1 in accordance with the present invention;

FIG. 3 illustrates a flow chart describing the enhanced new user registration capability provided by the enhanced DSL connection device in accordance with the present invention;

FIG. 4 illustrates a flow chart describing the automated dial back-up session capability provided by the enhanced DSL connection device in accordance with the present invention;

FIG. 5 illustrates a flow chart describing the automated back-up number management capability provided by the enhanced DSL connection device in accordance with the present invention;

FIG. 6 illustrates a flow chart describing the dial session management capability provided by the enhanced DSL connection device in accordance with the present invention; and

FIG. 7 illustrates a block diagram of the enhanced DSL connection device in the communications network shown in FIG. 1 in accordance with the present invention.

### DETAILED DESCRIPTION OF THE PREFERRED EMBODIMENT(S)

The present invention provides an enhanced DSL connection device referred to herein as “ECD” for providing enhanced connection capabilities to digital subscriber line (DSL) users. The ECD is a DSL connection device which is connected to the end of a telephone line terminating at a user premises. As such, the ECD takes the place of typical user DSL connection devices such as modems and gateways.

In general, the ECD is an enhanced connection hardware device for DSL Internet service and has many advantages. The ECD takes advantage of the dual data paths available with telephone service—the high-frequency path for digital data and the low-frequency path for analog data. The high-frequency path of a telephone line is a DSL. The DSL is used to establish a DSL connection between a user and an Internet Service Provider (ISP) to provide the user with an Internet session. The low-frequency path of the telephone line is an analog path. The analog path is used to establish a dial-up connection between the user and the ISP to provide the user with an Internet session. The ECD intelligently takes advantage of both paths to enhance Internet connection reliability between the user (e.g., the user's computer) and the ISP during an Internet session.

The ECD uses embedded logic to manage the two connections (the DSL connection and the dial-up connection) transparently to the user during an Internet session. The ECD is generally operable to make connection state changes in order to provide uninterrupted Internet service to the user (e.g., the user's computer) during an Internet session. For example, upon an established DSL connection between the user and an ISP being interrupted, the ECD establishes a dial-up connection between the user and the ISP to take the place of the interrupted DSL connection. As a result, the Internet session between the user and the ISP is not disrupted even though the DSL connection was interrupted. The DSL connection may have been interrupted as a result of a service outage along the DSL network path. In this case, once the service outage has been resolved, the ECD reestablishes the DSL connection between the user and the ISP to take the place of the dial-up connection established by the ECD. The ECD generally establishes DSL connections and dial-up connections between the user and an ISP in a manner transparent to the user.

The ECD monitors and stores every occasion when a connection state changes. In general, a connection state change occurs when the user uses the ECD to establish either a DSL connection or a dial-up connection to an ISP; when the ECD establishes a dial-up connection between the user and the ISP to take the place of an interrupted DSL connection between the user and the ISP; and when the ECD reestablishes a DSL connection between the user and the ISP to take the place of either a dial-up connection or an interrupted DSL connection between the user and the ISP.

The ECD is operable to share information indicative of the connection state changes with diagnostic software resident on the user's computer and with remote databases and tools used in the customer service operations of the DSL provider. The ECD is operable with software resident on the user's computer to display prompts to the user advising when the ECD is changing connection states, what the ECD is doing, and any decisions or actions required of the user.

Again, the ECD is a DSL connection device located at the user premises which replaces a conventional DSL connection device (such as a DSL modem or gateway) located at the user premises. The ECD, together with connection status software installed on the user's computer at the time of DSL registration with the DSL provider, provides all of the functionality of conventional DSL connection devices along with enhanced capabilities as detailed herein.

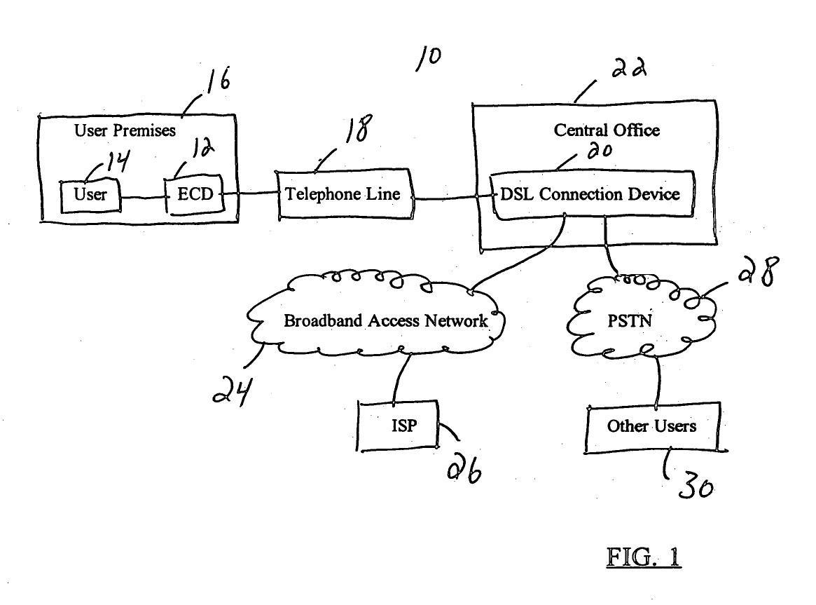

Referring now to FIG. 1, a block diagram of a communications network 10 having an enhanced DSL connection device 12 (i.e., ECD 12) for providing enhanced Internet service connection capabilities to a user 14 in accordance with the present invention is shown. ECD 12 and user 14 are located at user premises 16. User 14 generally includes a user computer and a user telephone which are connected to a telephone line 18 via ECD 12. Telephone line 18 connects ECD 12 to a DSL connection device 20 (such as a DSLAM or RT) located in a central office (CO) 22 of a telecommunication service provider.

ECD 12 and DSL connection device 20 connected on separate ends of telephone line 18 enable a DSL provider to provide DSL services to user 14. That is, ECD 12 and DSL connection device 20 enable digital data and analog data (such as voice telephony and voice-based modem communications) to be transmitted between user 14 and CO 22 via separate data paths of telephone line 18. The separate data paths of telephone line 18 include the DSL (digital subscriber line) for the digital data and the analog path for the analog data.

DSL connection device 20 connects to a broadband access network 24 such as an asynchronous transfer mode (ATM) network that connects to ISPs such as ISP 26 shown in FIG. 1. As such, user computer 14 and ISP 26 are enabled to communicate digital data to one another over a DSL network path which includes the DSL of telephone line 18. Consequently, user 14 (e.g., user's computer) is provided with Internet service. The DSL network path extends between user 14, ECD 12, the DSL of telephone line 18, DSL connection device 20 in CO 22, broadband access network 24, and ISP 26. The DSL network path established between user 14 and ISP 26 is a DSL connection and, in this case, the user is provided with DSL Internet service.

More particularly, DSL connection device 20 multiplexes digital data received from user 14 via ECD 12 and the DSL of telephone line 18 and then transmits this digital data through broadband access network 24 to ISP 26. Similarly, DSL connection device 20 de-multiplexes digital data received from ISP 26 via broadband access network 24 and then transmits this digital data through the DSL of telephone line 18 to ECD 12 for receipt by user 14.

DSL connection device 20 also connects with PSTN 28 thereby connecting user 14 (e.g., the user's computer and the user's telephone) to the PSTN via the analog path of telephone line 18. PSTN 28 connects with other users 30 (e.g., other user telephones) and the ISPs including ISP 26. As a result, user 14 is connected to ISP 26 and other users 30. Thus, user 14 and other users 30 are enabled to communicate analog data such as voice telephony communications with one another using telephones over an analog network path which includes the analog path of telephone line 18. As a result, user 14 is provided with traditional telephone service. The analog network path extends between user 14, ECD 12, the analog path of telephone line 18, DSL connection device 20 in CO 22, PSTN 28, and other users 30. Likewise, user 14 (e.g., user's computer) and ISP 26 are enabled to communicate digital data which has been transformed into analog data with one another using voice-based modems over the analog network path. The analog network path established between user 14 and ISP 26 is a dial-up connection and, in this case, the user is provided with dial-up Internet service.

More particularly, DSL connection device 20 uses filtering to divert the analog data carried by the analog path of telephone line 18 to traditional switching equipment (not shown) in CO 22 for PSTN 28, thereby forming a separate circuit independent of the DSL network path. As such, a service outage anywhere along the DSL network path does not affect the analog network path.

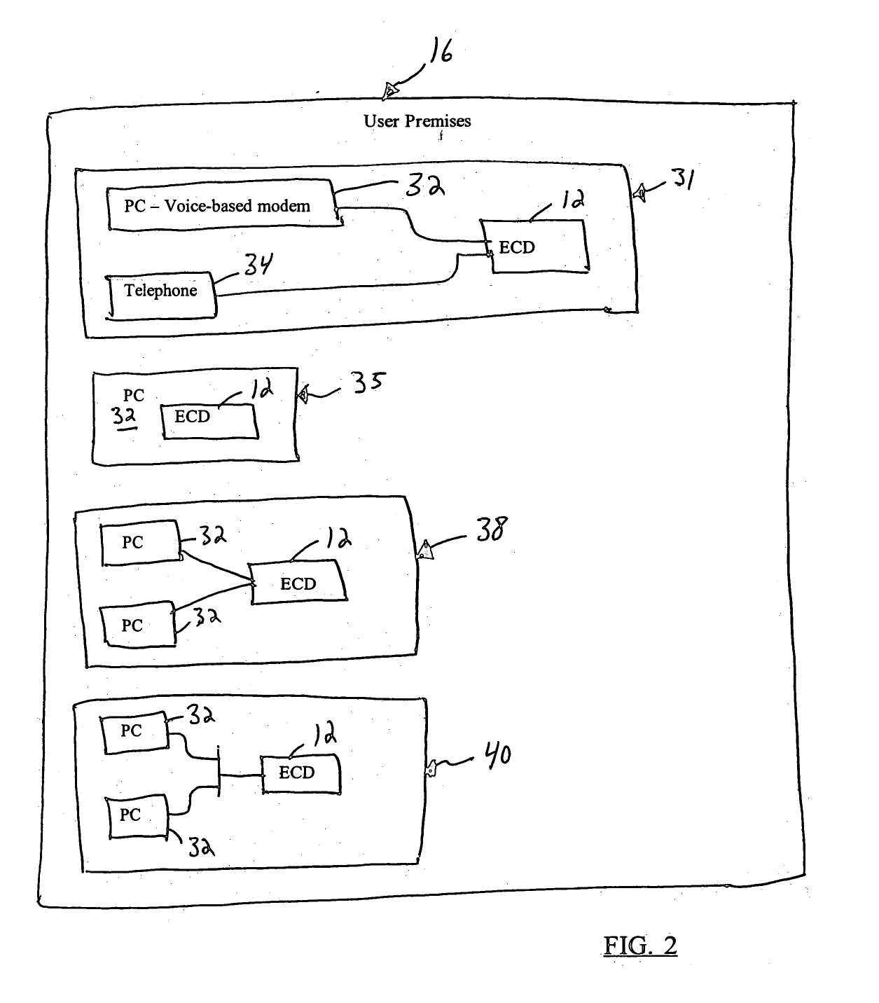

Referring now to FIG. 2, with continual reference to FIG. 1, a block diagram of user premises 16 in communications network 10 in accordance with the present invention is shown. As noted, user premises 16 generally includes a user telephone and a user computer which are connected to ECD 12. However, there are many possible variations to the general configuration and some of these variations are shown in FIG. 2.

For example, in a general configuration 31, user premises 16 includes a user computer such as a personal computer (PC) 32 connected to ECD 12. PC 32 may include a voice-based modem for establishing dial-up Internet connections between user 14 and ISP 26. During a dial-up Internet connection, the voice-based modem of PC 32 transforms digital data from the PC into analog data for transmission to ISP 26 via ECD 12 and the analog network path. Similarly, during a dial-up Internet connection, the voice-based modem of PC 32 transforms analog data transmitted from ISP 26 to ECD 12 via the analog network path (the ISP transmitting digital data which a voice-based modem at CO 22 transforms into the analog data) for receipt by the PC. During a DSL Internet connection, the voice-based modem of PC 32 is not used as the data transferred between the PC and ISP 26 over the DSL network path is digital data. In configuration 31, user premises 16 further includes a user telephone 34 which is connected to ECD 12. User telephone 34 transmits and receives analog data to and from ECD 12 via the analog network path for voice telephony communications with telephones of other users 30. As noted, the DSL network path and the analog network path can be used simultaneously. As such, a DSL Internet connection can take place between PC 32 and ISP 26 while voice telephony communications take place between user telephone 34 and the telephones of other users 30. In configuration 31, ECD 12 takes the place of a typical external DSL modem.

In another configuration 35, user premises 16 includes a PC 36 in which ECD 12 is incorporated into the PC. In this configuration, ECD 12 takes the place of a typical network interface card (NIC) DSL modem. This configuration also typically includes a telephone such as user telephone 34 which is separately connected to telephone line 18. In another configuration 38, user premises 16 includes a plurality of PCs 32 which are separately connected to ECD 12 by way of a local area network (LAN). In this configuration, ECD 12 takes the place of a typical DSL gateway. This configuration also typically includes a telephone such as user telephone 34 which is separately connected to ECD 12. In another configuration 40, user premises 16 includes a plurality of PCs 32 which are separately connected by way of a single connection and a LAN to ECD 12. In this configuration, ECD 12 takes the place of a typical DSL router. This configuration also typically includes a telephone such as user telephone 34 which is separately connected to ECD 12.

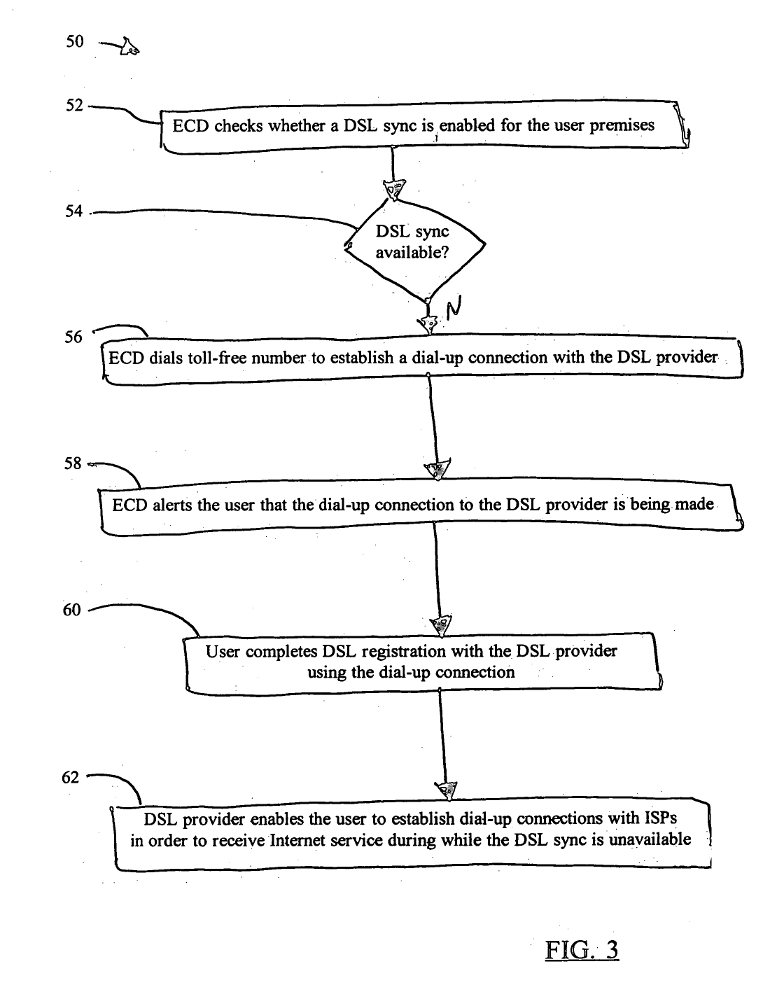

Referring now to FIG. 3, with continual reference to FIG. 1, a flow chart 50 describing the enhanced new user registration capability provided by ECD 12 in accordance with the present invention is shown. ECD 12 initially checks to see whether a DSL provider has enabled a DSL sync for user premises 16 when the ECD is installed at the user premises as shown in block 52. If ECD 12 determines in decision block 54 that the DSL sync is not available, then the ECD uses an internal voice-based modem to dial a pre-programmed toll-free telephone number in order to establish a dial-up connection with a registration server of the DSL provider as shown in block 56. ECD 12 alerts user 14 that the dial-up connection to the registration server of the DSL provider is being made as shown in block 58. The alert also indicates that a dial-up connection is being made in lieu of a DSL connection. ECD 12 generates the alert by passing connection state information to a registration application installed on the user's computer. The dial-up connection to the registration server of the DSL provider enables user 14 to complete their DSL registration in dial-up mode as shown in block 60. The DSL registration includes user 14 creating a password and providing information (such as street address) indicative of the location of user premises 16. Upon DSL registration being completed, the DSL provider enables user 14 to establish dial-up connections with ISP 26 in order to receive Internet service as shown in block 62.

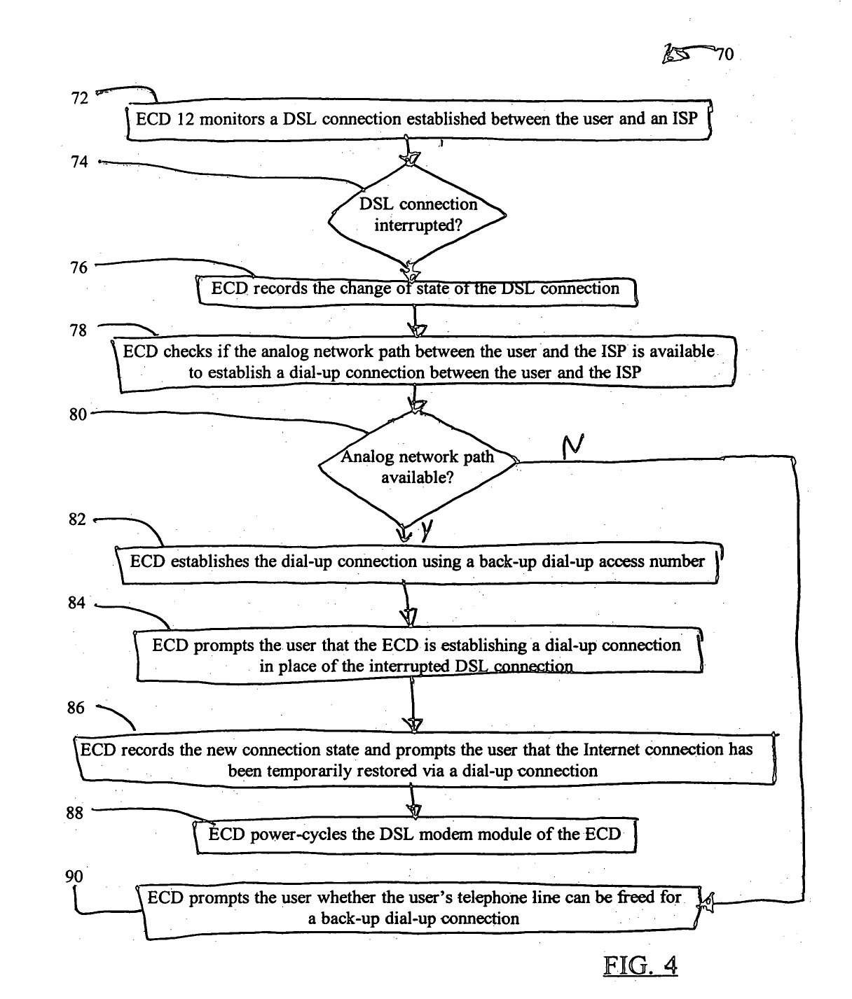

Referring now to FIG. 4, with continual reference to FIG. 1, a flow chart 70 describing the automated dial back-up session capability provided by ECD 12 in accordance with the present invention is shown. Initially, ECD 12 monitors a DSL connection established between user 14 (e.g., user's computer) and ISP 26 as shown in block 72. If ECD 12 determines in decision block 74 that the DSL connection has been interrupted, then the ECD records the change of state of the DSL connection as shown in block 76. ECD 12 then checks to see if the analog network path between user 14 and ISP 26 is available to establish a dial-up connection between the user and the ISP as shown in block 78. If ECD 12 determines in decision block 80 that the analog network path is available for establishing the dial-up connection, then the ECD establishes the dial-up connection using one or more stored back-up access numbers as shown in block 82.

The stored back-up access numbers are previously provided by the DSL provider to ECD 12 at the time of user registration. The DSL provider provides ECD 12 with the back-up access numbers that are appropriate for user 14 based on the geographic location of the user. As noted above, during the registration process, user 14 provides the user's geographic location information to the DSL provider. Alternatively or additionally, the DSL provider may obtain the user's geographic location information using the ANI associated with the toll-free registration call established from user premises 16 to the DSL provider.

While establishing the dial-up connection, ECD 12 prompts user 14 (by way of the user computer) that the ECD is establishing a dial-up connection in place of the interrupted DSL connection as shown in block 84. Once the back-up dial-up connection is established, ECD 12 records the new connection state and prompts user 14 that the Internet connection has been temporarily restored via a dial-up connection as shown in block 86. Following establishment of a back-up dial-up connection, ECD 12 automatically power-cycles the DSL modem module of the ECD as shown in block 88. This automates one of the primary connection troubleshooting steps for user 14 thereby potentially reducing user service calls, expense, and user inconvenience.

If ECD 12 determines in decision block 80 that the analog network path is not available for establishing the dial-up connection, then the ECD prompts user 14 (by way of the user computer) whether the user's telephone line can be freed up for a back-up dial-up connection as shown in block 90. If user 14 responds affirmatively, ECD 12 establishes the back-up dial-up connection as described.

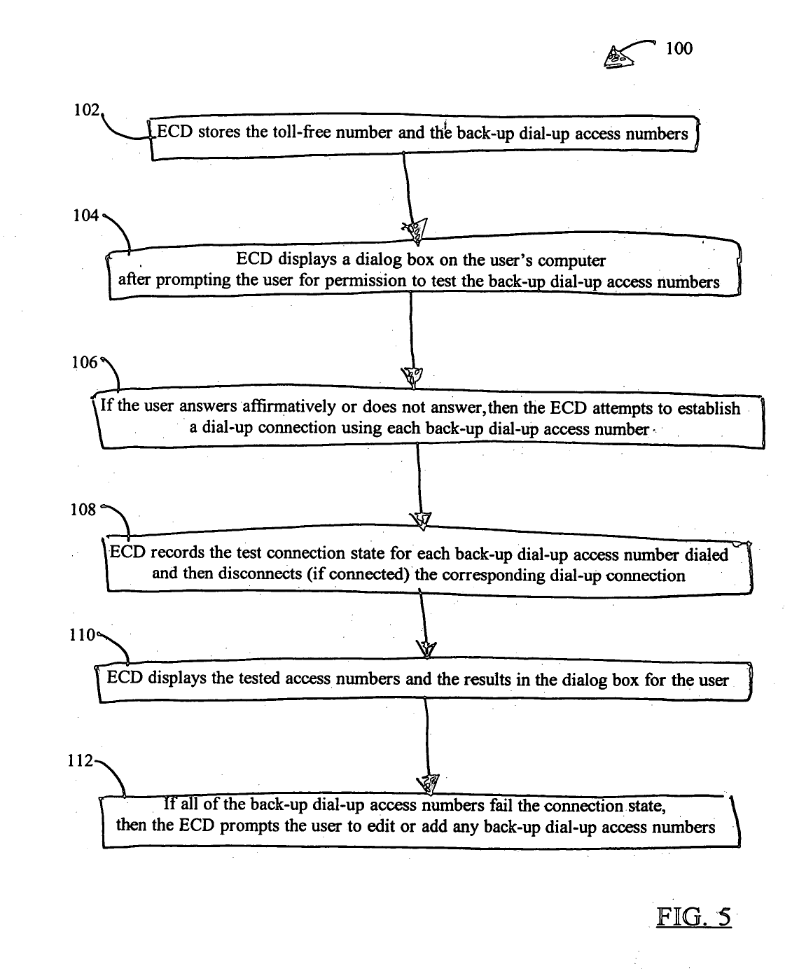

Referring now to FIG. 5, with continual reference to FIG. 1, a flow chart 100 describing the automated back-up number management capability provided by ECD 12 in accordance with the present invention is shown. ECD 12 initially stores the toll-free configuration number and the sequence of back-up dial-up access numbers as shown in block 102. Again, the back-up dial-up access numbers are passed down from the DSL provider to ECD 12 and stored by the ECD during the user registration process as described. Thereafter, ECD 12 periodically tests each of the stored back-up dial-up access numbers through an automated process and stores the test results in a separate connection state register.

The periodic automated back-up access number verification is set to occur at configurable intervals. ECD 12 displays a dialog box on the user's computer after first prompting user 14 for permission to test the back-up dial-up access numbers as shown in block 104. If user 14 answers yes or does not answer, then ECD 12 dials out and attempts to establish a dial-up connection with each back-up dial-up access number as shown in block 106. ECD 12 records the test connection state for each back-up dial-up access number dialed and then disconnects (if connected) the dial-up connection as shown in block 108. ECD 12 displays the tested access numbers and the results in the dialog box for user 14 to see as shown in block 110. If all of the back-up dial-up access numbers fail the connection state, then ECD 12 prompts user 14 whether to edit or add any back-up dial-up access numbers as shown in block 112. The DSL provider may also edit or add any back-up dial-up access numbers during any previously established DSL connections and any previously established dial-up connections. ECD 12 tests any new or edited back-up dial-up access numbers in the manner described and records the new test connection states.

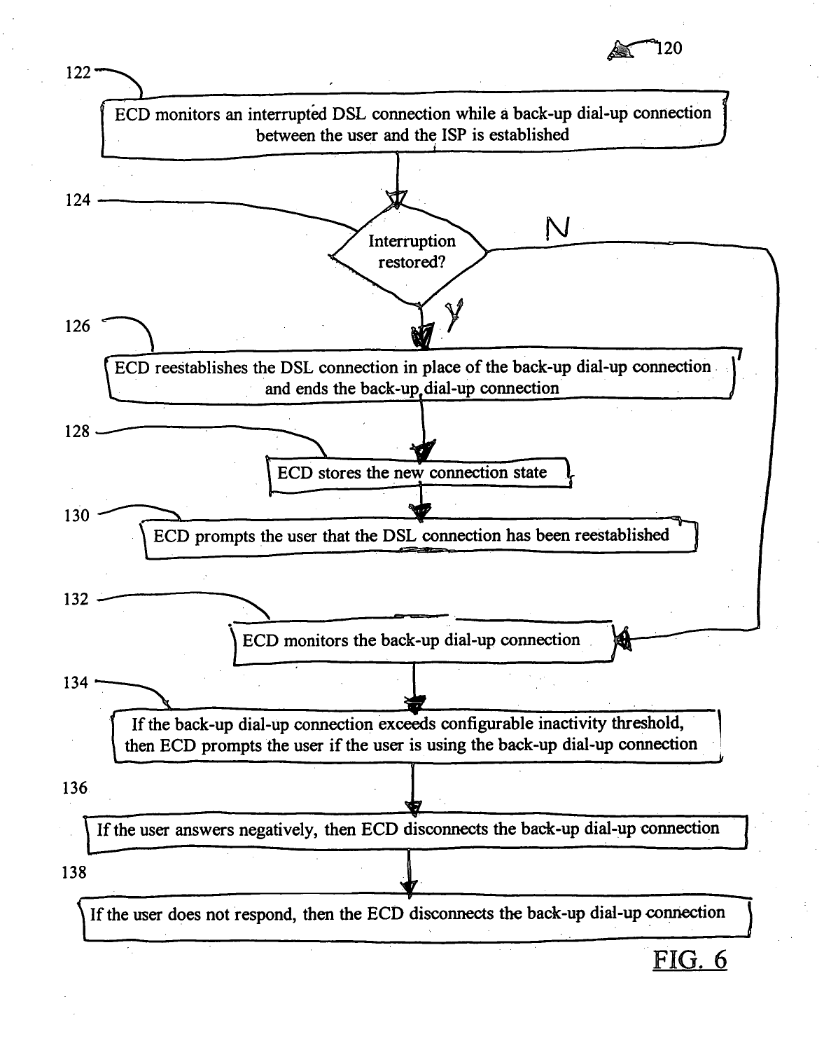

Referring now to FIG. 6, with continual reference to FIG. 1, a flow chart 120 describing the dial session management capability provided by ECD 12 in accordance with the present invention is shown. ECD 12 initially monitors an interrupted DSL connection between user 14 and ISP 26 during an established back-up dial-up connection between the user and the ISP as shown in block 122. If ECD 12 determines in decision block 124 that the interruption affecting the DSL connection has been restored, then the ECD reestablishes the DSL connection in place of the back-up dial-up connection and ends the back-up dial-up connection as shown in block 126. ECD 12 stores the new connection state as shown in block 128 and prompts the user (by way of the user computer) that the DSL connection has been reestablished as shown in block 130.

If ECD 12 determines in decision block 124 that the interruption affecting the DSL connection still persists, then the ECD monitors the duration and activity levels of the back-up dial-up connection as shown in block 132. If the back-up dial-up connection exceeds configurable inactivity threshold, then the ECD 12 prompts a user computer application to display a dialog box on the user's computer asking user 14 if the back-up dial-up connection is still in use as shown in block 134. If user 14 answers negatively, then ECD 12 disconnects the back-up dial-up connection as shown in block 136. ECD 12 also prompts user 14 that the back-up dial-up connection has been halted and will either be restored automatically when the DSL connection is available again or can be manually restarted by the user by clicking a button on the dialog box. If user 14 does not respond to the prompt regarding whether the back-up dial-up connection is still in use after a set interval, then ECD 12 disconnects the back-up dial-up connection assuming that this connection is not being used as shown in block 138. In the latter case, ECD 12 further stores the non-connection state and displays the dialog box as described.

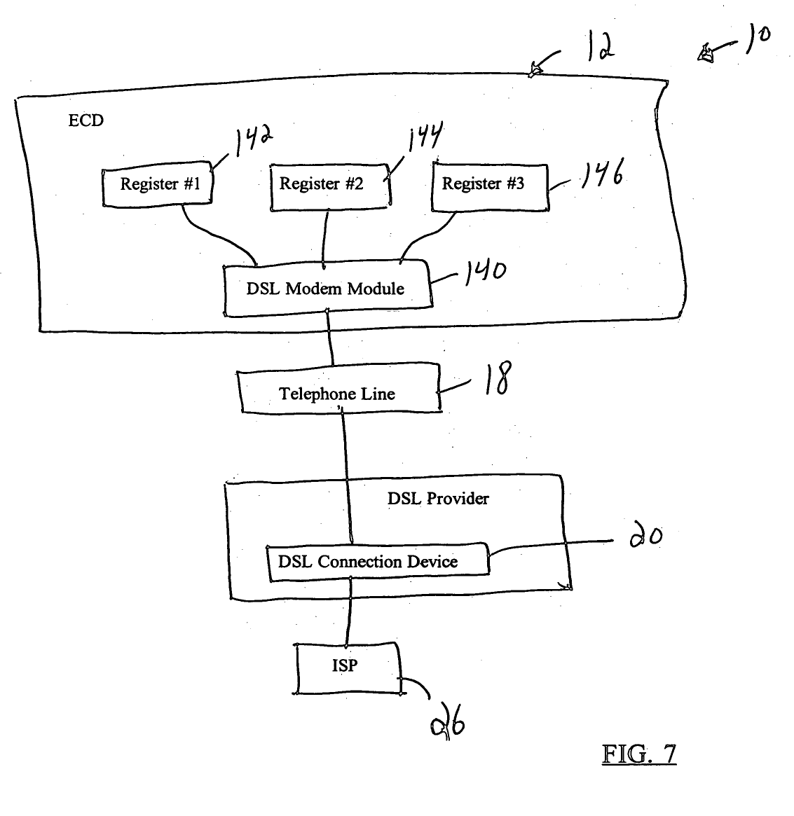

Referring now to FIG. 7, with continual reference to FIG. 1, a block diagram of ECD 12 in communications network 10 in accordance with the present invention is shown. As described, ECD 12 includes a modem module 140 for establishing in conjunction with DSL connection device 20 the DSL and dial-up connections between user 14 and ISP 26 via telephone line 18. A DSL provider is operable to communicate with modem module 140 during a DSL or dial-up connection in order to send to and install software changes on ECD 12. The software changes are intended to expand the functionality of ECD 12.

ECD 12 further includes a set of non-volatile registers 142, 144, and 146. ECD 12 stores the connection state data in registers 142, 144, and 146. More particularly, ECD 12 stores a configurable number of time-stamped connection states recorded before a first DSL connection is established for an Internet session (i.e., stores data indicative of the dial-up connections established before the first DSL connection is established). ECD 12 stores a configurable number of time-stamped connection states recorded other than before the first DSL connection was established (i.e., stores data indicative of the DSL and dial-up connections established after the first DSL connection was established). ECD 12 stores a configurable number of time-stamped test states recorded (i.e., stores data indicative of the tested back-up dial-up access numbers). ECD 12 enables the stored connection data to be accessible to an authorized user (e.g., a service representative of the DSL provider) connecting to the ECD. The authorized user can view or download the contents of registers 142, 144, and 146.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A communications network comprising:
a user premises having a user digital subscriber line (DSL) device;
a central office (CO) DSL device; and
a telephone line connected at one end to the user DSL device and connected at the other end to the CO DSL device;
the CO DSL device connected through a broadband access network to an Internet Service Provider (ISP) such that a DSL network path extends from the user DSL device over a digital path of the telephone line to the CO DSL device and through the broadband access network to the ISP in order to enable a DSL connection to be established between the user premises and the ISP;
the CO DSL device connected through the public switched telephone network (PSTN) to the ISP such that an analog network path extends from the user DSL device over an analog path of the telephone line to the CO DSL device and through the PSTN to the ISP in order to enable a dial-up connection to be established between the user premises and the ISP;
wherein a user at the user premises uses the user DSL device to establish a DSL connection between the user premises and the ISP along the DSL network path;
wherein upon the DSL connection established by the user between the user premises and the ISP being interrupted due to an outage along the DSL network path, the user DSL device automatically establishes a dial-up connection between the user premises and the ISP along the analog network path to replace the interrupted DSL connection.

2. The communications network of claim 1 wherein:
the user DSL device automatically reestablishes the DSL connection to replace the dial-up connection established by the user DSL device upon the outage along the DSL network path being remedied.

3. The communications network of claim 1 wherein:
the user DSL device determines whether the analog network path is available prior to automatically establishing the dial-up connection between the user premises and the ISP along the analog network path, wherein if the analog network path is available then the user DSL device automatically establishes the dial-up connection between the user premises and the ISP along the analog network path.

4. The communications network of claim 3 wherein:
if the analog network path is unavailable, the user DSL device prompts the user to inquire whether the analog network path can be freed for the user DSL device to automatically establish the dial-up connection between the user premises and the ISP along the analog network path, wherein once the analog network path is freed the user DSL device automatically establishes the dial-up connection between the user premises and the ISP along the analog network path.

5. The communications network of claim 1 wherein:
the user DSL device records a connection time-stamped state change when the user DSL device automatically establishes the dial-up connection between the user premises and the ISP along the analog network path to replace the interrupted DSL connection.

6. The communications network of claim 5 wherein:
the user DSL device automatically reestablishes the DSL connection to replace the dial-up connection established by the user DSL device upon the outage along the DSL network path being remedied.

7. The communications network of claim 6 wherein:
the user DSL device records a connection time-stamped state change when the user DSL device automatically reestablishes the DSL connection to replace the dial-up connection established by the user DSL device upon the outage along the DSL network path being remedied.

8. The communications network of claim 7 wherein:
the user DSL device records a connection time-stamped state change each time the user uses the user DSL device to establish a DSL connection between the user premises and the ISP along the DSL network path.

9. The communications network of claim 1 wherein:
the user DSL device automatically power cycles a DSL modem module of the user DSL device upon the DSL connection established by the user between the user premises and the ISP being interrupted due to the outage.

10. The communications network of claim 1 wherein:
the presence of a DSL sync is required prior to the user DSL device being used to establish the DSL connection between the user premises and the ISP along the DSL network path;
wherein the user DSL device checks for the presence of the DSL sync;
wherein if the DSL sync is not present, the user DSL device automatically makes a toll-free dial-up connection between the user premises and a DSL provider connected to the CO in order for the user to register DSL service with the DSL provider;
wherein upon the user registering the DSL service with the DSL provider, the DSL provider allows the user to use the user DSL device to establish a dial-up connection between the user premises and the ISP along the analog network path while the DSL sync is absent.

11. The communications network of claim 10 wherein:
the user DSL device records a connection time-stamped state change each time the user uses the user DSL device to establish a dial-up connection between the user premises and the ISP along the analog network path.

12. The communications network of claim 1 wherein:
the user DSL device automatically establishes a dial-up connection between the user premises and the ISP along the analog network path by dialing a back-up dial-up access number;
wherein the user DSL device stores a plurality of back-up dial-up access numbers;
wherein the user DSL device automatically tests the back-up dial-up access numbers at configurable intervals by dialing the back-up dial-up access numbers one at a time to determine whether a dial-up connection between the user premises and the ISP along the analog path can be established upon a back-up dial-up access number being dialed.

13. The communications network of claim 12 wherein:
the user DSL device records a test connection time-stamped state for a back-up dial-up access number each time the back-up dial-up access number is tested.

14. The communications network of claim 1 wherein:
the user DSL device monitors duration and activity level of a dial-up connection established between the user premises and the ISP along the analog network path;
wherein the user DSL device automatically disconnects the dial-up connection if the duration and activity level of the dial-up connection exceeds a configurable inactivity threshold.

15. The communications network of claim 14 wherein:
the user DSL device records a connection time-stamped state change each time the user DSL device automatically disconnects the dial-up connection.

16. A method for use with a communications network including a user premises having a user digital subscriber line (DSL) device, a central office (CO) DSL device, and a telephone line connected at one end to the user DSL device and connected at the other end to the CO DSL device, the method comprising:
connecting the CO DSL device through a broadband access network to an Internet Service Provider (ISP) such that a DSL network path extends from the user DSL device over a digital path of the telephone line to the CO DSL device and through the broadband access network to the ISP in order to enable a DSL connection to be established between the user premises and the ISP;
connecting the CO DSL device through the public switched telephone network (PSTN) to the ISP such that an analog network path extends from the user DSL device over an analog path of the telephone line to the CO DSL device and through the PSTN to the ISP in order to enable a dial-up connection to be established between the user premises and the ISP;
using the user DSL device, by a user at the user premises, to establish a DSL connection between the user premises and the ISP along the DSL network path; and
upon the DSL connection between the user premises and the ISP being interrupted due to an outage along the DSL network path, automatically establishing, by the user DSL device, a dial-up connection between the user premises and the ISP along the analog network path to replace the interrupted DSL connection.

17. The method of claim 16 further comprising:
automatically reestablishing, by the user DSL device, the DSL connection to replace the dial-up connection upon the outage along the DSL network path being remedied.

18. The method of claim 17 further comprising:
recording, by the user DSL device, a connection time-stamped state change each time the user DSL device automatically establishes the dial-up connection and reestablishes the DSL connection.

19. The method of claim 16 further comprising:
determining, by the user DSL device, whether the analog network path is available prior to automatically establishing the dial-up connection; and
automatically establishing, by the user DSL device, the dial-up connection between the user premises and the ISP along the analog network path if the analog network path is available.

20. The method of claim 19 further comprising:
wherein if the analog network path is unavailable,
prompting, by the user DSL device, the user to inquire whether the analog network path can be freed for the dial-up connection; and
automatically establishing, by the user DSL device, the dial-up connection once the analog network path is freed.
